(19) United States
(12) Patent Application Publication
(10) Pub. No.: US 2006/0041846 A1
(43) Pub. Date: Feb. 23, 2006

(54) Method of window management for a windowing system

(75) Inventors: Eric Leonard Masselle, Raleigh, NC (US); Patrick Gabriel McGowan, Stoney Creek, NC (US)

Correspondence Address: GUERIN & RODRIGUEZ, LLP, 5 MOUNT ROYAL AVENUE, MOUNT ROYAL OFFICE PARK, MARLBOROUGH, MA, 01752, US

(73) Assignee: International Business Machines Corporation, Armonk, NY (US)

(21) Appl. No.: 10/922,189

(22) Filed: Aug. 19, 2004

(51) Int. Cl. G06F 17/00

(52) U.S. Cl. 715/793; 715/804; 715/794

(57) ABSTRACT

A method of organizing a plurality of windows for display to a user is described. The windows are displayed in a cascade stack. One of the windows is selected as an active window and is displayed in a preferred display state such as a maximized window, a window having a predefined window size or a window at a predetermined location in the display. Once the user no longer wishes to use the active window, the window is returned to the cascade stack in a position dependent on the particular cascade mode selected by the user.

### FIELD OF THE INVENTION

The invention relates to the presentation of windows on a computer display screen. More specifically, the invention relates to the organization of windows presented in a cascade arrangement during subsequent user interactions.

### BACKGROUND OF THE INVENTION

Various windowing systems such as Microsoft Windows® operating systems allow a user to view open windows in a cascade stack or tile array in a user display. In a typical cascade stack open and displayed windows are arranged such that the corners of each window are displaced relative to other displayed windows by a uniform distance and direction. However, the cascade arrangement is not maintained through subsequent window interactions by the user. For example, a user can select, resize and reposition one of the windows from the cascade stack. Similarly, other windows may be removed from the cascade stack and resized and repositioned by the user. The result can be a cluttered display which is increasingly difficult to navigate as work progresses. Tile arrangements also suffer from disorganization as user actions progress.

Portals enable the display of web components, or “portlets”, for self-contained applications or content. By way of example, portlets can include e-mail, search engines, news sites, online shopping, chat sites, discussion forums and various other information sources including weather sites, map sites, stock quote sources, and other online resources. The size of a portlet windows is generally restricted by the size of the portal display thus the presentation of information within the portlet window is also limited.

### SUMMARY OF THE INVENTION

In one aspect, the invention features a method of organizing a plurality of windows for display to a user. The windows are displayed in a cascade stack. Each window has a first position in the cascade stack and an ordered position relative to the other windows. One of the windows is selected to be an active window. The selected window is displayed in a preferred display state. The selected window is then displayed in the cascade stack in a second position.

In another aspect, the invention features a computer readable medium for organizing a plurality of windows for display to a user. The computer readable medium includes instructions to cause a processor to display the windows in a cascade stack. Each window has a first position in the cascade stack and an ordered position relative to the other windows. The computer readable medium also includes instructions to cause the processor to enable the user to select one of the windows to be an active window, to display the selected window in a preferred display state and to display the selected window in the cascade stack in a second position.

In another aspect, the invention features a computer data signal embodied in a carrier wave for organizing a plurality of windows for display to a user. The computer data signal includes program code for displaying the windows in a cascade stack. Each window has a first position in the cascade stack and an ordered position relative to the other windows. The computer data signal also includes program code for selecting one of the windows to be an active window, program code for displaying the selected window in a preferred display state, and program code for displaying the selected window in the cascade stack in a second position.

In another aspect, the invention features an apparatus for organizing a plurality of windows for display to a user. The apparatus includes means for displaying the windows in a cascade stack. Each window has a first position in the cascade stack and an ordered position relative to the other windows. The apparatus also includes means for selecting one of the windows to be an active window, means for displaying the selected window in a preferred display state and means for displaying the selected window in the cascade stack in a second position.

### BRIEF DESCRIPTION OF THE DRAWINGS

The above and further advantages of this invention may be better understood by referring to the following description in conjunction with the accompanying drawings, in which like numerals indicate like structural elements and features in various figures. The drawings are not necessarily to scale, emphasis instead being placed upon illustrating the principles of the invention.

FIG. 1 is an illustration of a display of windows arranged in a cascade stack.

FIG. 2 is a flowchart representation of a method of organizing a plurality of windows for display to a user according to an embodiment of the invention.

FIG. 3 is an illustration of the display of FIG. 1 showing a selected window in a preferred display state according to an embodiment of the invention.

FIG. 4 is an illustration of the display of FIG. 3 after return of the selected window to the cascade stack based on a fixed static mode according to an embodiment of the invention.

FIG. 5 is an illustration of the display of FIG. 3 after return of the selected window to the cascade stack based on a shuffle mode according to another embodiment of the invention.

FIG. 6 is an illustration of a window permanently removed from cascade mode arrangement to facilitate the copying of information between windows according to an embodiment of the invention.

### DETAILED DESCRIPTION

The present invention relates to a method of organizing and presenting a display of windows to a user. Windows are initially displayed in a cascade stack. A window is selected from the cascade stack as an active window to allow the user to interact with the associated window-based application or document. The selected window is displayed in a preferred display state. For example, the preferred display state can be a maximized window or a window positioned at a predetermined window size. When the user wishes to work in another window, the selected window is returned to the cascade stack. The selected window can be returned to its original position in the stack or it can be positioned at the top of the stack (i.e., the top position). The position of the windows with respect to each other (i.e., the ordered positions) is maintained when the window is returned to the cascade stack. Alternatively, the returned window can be assigned a new ordered position in the stack and the ordered positions of the other windows are adjusted accordingly. The ability to maintain a cascade mode throughout user interactions subsequent to the initial display of the windows in a cascade stack provides a significant organizational enhancement over existing cascade features for windows. Moreover, portlets contained in web portals can be displayed at increased size and managed as windows in a cascade stack. Consequently, information provided in a portlet is not limited to size constraints inherent in the associated web portal page.

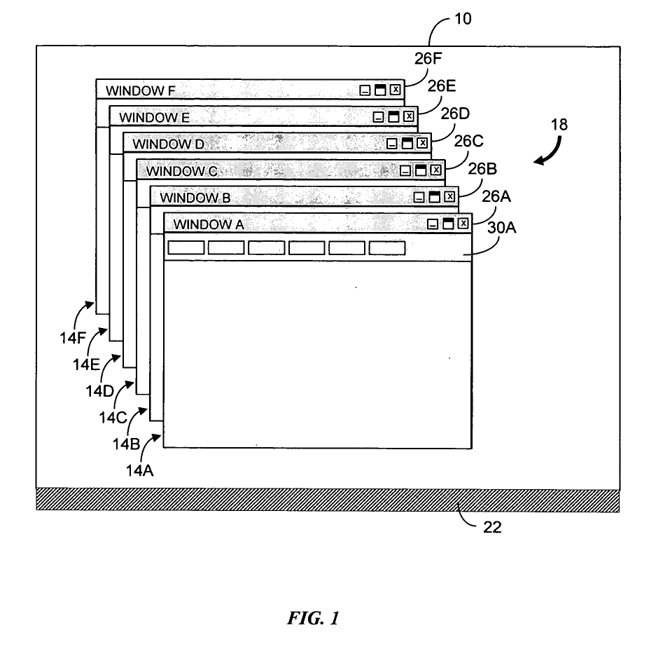

FIG. 1 illustrates a display 10 having a plurality of windows 14A to 14F (generally 14) arranged in a cascade stack 18 according to a common cascade feature provided in various windows systems. The cascade feature can be implemented, for example, by a user action such as a mouse click on a task bar 22 or desktop display and a user selection of the feature from the resulting menu. In another example, the user can set a preference to routinely provide continuous cascade mode behavior. The cascade stack 18 presents the windows in an orderly arrangement in which each window is 14 is displayed with the same horizontal and vertical dimensions. The upper left corner of each window 14 is shifted upward and to the left in the display 10 by a fixed distance from its preceding window 14 in the cascade stack 18 so that its title bar remains visible to the user. For example, Window B 14B is behind Window A 14A but is shifted so that its title bar 26B is visible. A user interacts with the windows 14 as various associated documents or applications are accessed. Once a user retrieves a window 14 from the cascade stack 18, however, the user cannot conveniently return the window 14 to the stack 18 and maintain an orderly display 10. Subsequent interactions with other windows 14 in the cascade stack 18 can result in a more disorganized display 10.

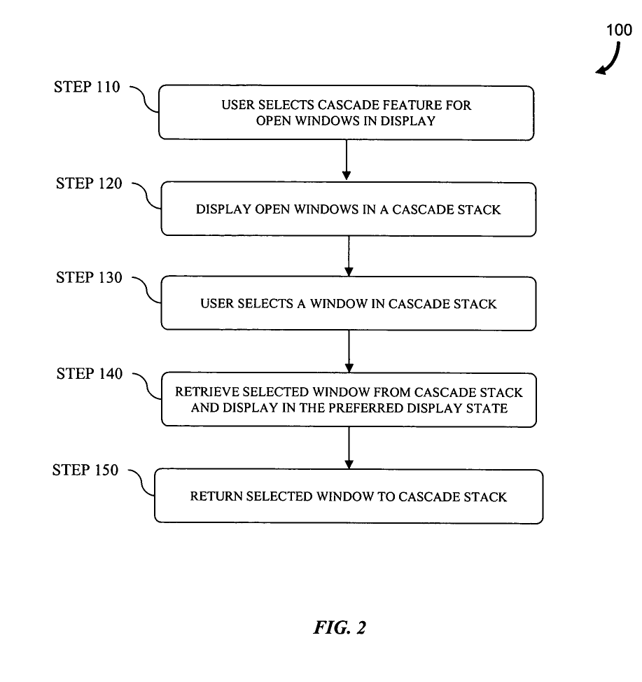

FIG. 2 shows a flowchart representing a method 100 of organizing windows for display to a user according to an embodiment of the invention. A user requests (step 110) a cascade arrangement of open windows 14 through a user action. The user action can be a mouse click and the selection of the cascade feature is selected from a resulting menu. Alternatively, the user can select the cascade feature from an application menu bar (see, for example, the menu bar 30A for Window A 14A in FIG. 1). The windows 14 are then displayed (step 120) as a cascade stack 18 as shown in FIG. 1. The user selects (step 130) one of the windows 14 in the display 10 for use. Selection of the active window is made, for example, by positioning a pointer over the title bar 26 or other visible region of a window 14 and clicking an input device such as a mouse.

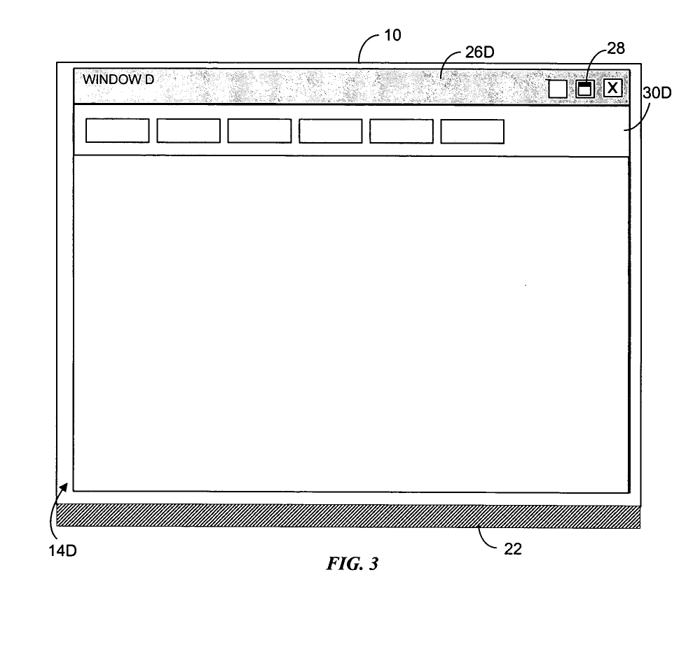

The selected window 14 is retrieved (step 140) from the cascade stack 18 and displayed in the preferred display state. The preferred display state may be a maximized window, a predetermined window size or a predetermined location in the display 10. Display of the selected window 14 in the preferred display state can block the windows remaining in the cascade stack 18. FIG. 3 shows Window D 14D as a selected window in at a larger window size that prevents the user from viewing the cascade stack 18.

The selected window is returned (step 150) to the cascade stack 18 in its original position when it is no longer required for use by the user or when the user wants to work with a different window 14. The selected window is returned to the cascade stack 18 by executing a corresponding user action such as clicking the “Restore Down” icon 28 in the title bar 26. The user can select other windows 14 and return them to the cascade stack 18 by repeating steps 130, 140 and 150.

Each window 14 has an ordered position relative to the other windows 14 in the cascade stack 18. Window A 14A through Window F 14F are in the first through sixth positions, respectively, and have ordered position values of one through six, respectively. In the illustrative example described above, the ordered positions of the windows 14 do not change because the active window is returned to its original position in the cascade stack 18 according to a “solo static mode.”

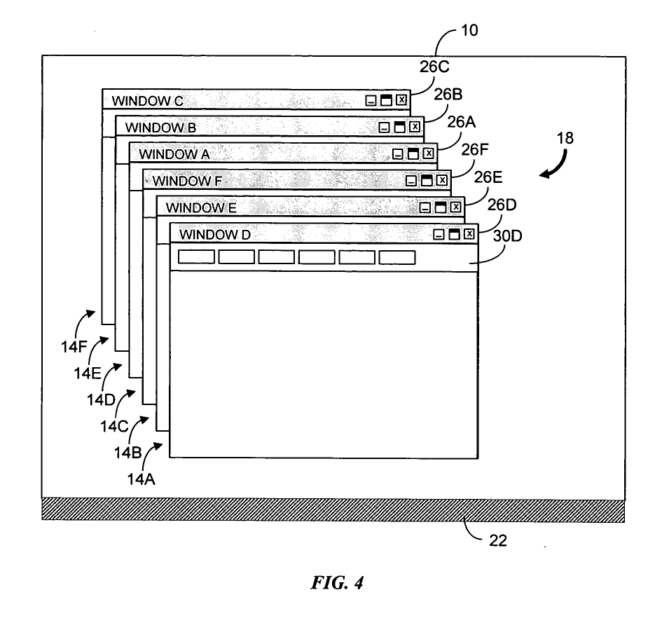

In another embodiment the selected window is returned (step 150) to a position other than its original position in the cascade stack 18 according to a “fixed static mode” and the ordered positions of the windows 14 remains unchanged. The display of the windows 14 in the fixed static mode is similar to a rotating card file in which the order of the cards relative to each other remains unchanged regardless of which card appears on top. For example, if Window D 14D which has an ordered position value of four is the selected window as shown in FIG. 3, returning Window D 14D to the top position in the cascade stack 18 results in a top to bottom display of Window D 14D, Window E 14E, Window F 14F, Window A, 14A, Window B 14B and Window C 14C as shown in FIG. 4. The value of the ordered positions of the windows 14 as displayed from top to bottom are thus four, five, six, one, two and three, respectively.

Advantageously, the solo static and fixed static modes maintain an orderly arrangement of windows 14. Thus a user can better remember where to find a particular window 14 for later use.

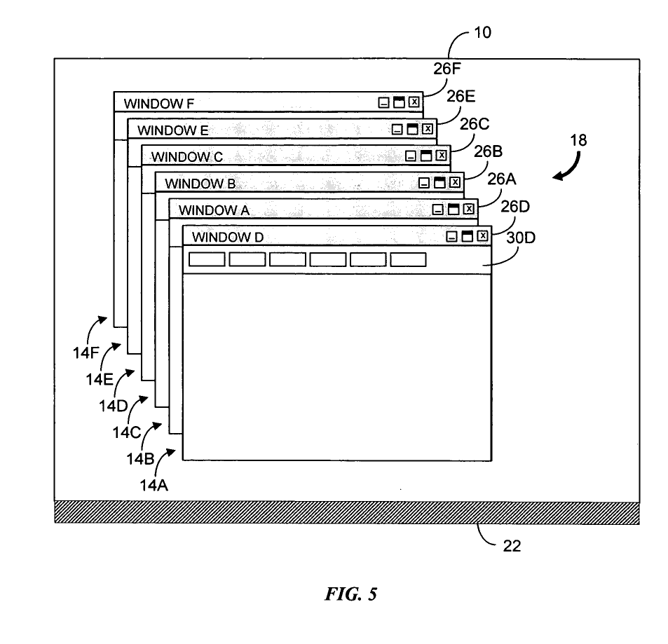

In another embodiment, the ordered positions of the windows 14 changes when the selected window is returned to the cascade stack 18 according to a “shuffle mode.” Shuffle mode is particularly useful for users requiring frequent access to recently selected windows. Again using Window D 14D as an example of a selected window as shown in FIG. 3, returning the selected window to the top position in the cascade stack 18 while in the shuffle mode effectively removes Window D 14D from its position in the cascade stack 18 and causes an adjustment in the ordered position values of the six windows 14 as shown in FIG. 5. In this example, the value of the ordered position of Window D 14D changes from four to one. The ordered position values of Window A 14A, Window B 14B and Window C 14C are incremented by one while the ordered position values of Window E 14E and Window F 14F remain unchanged. The ordered positions are preserved through subsequent selection and return of windows 14 in the cascade stack 18 unless the user remains in or later changes to shuffle mode for selection of another window 14.

Fixed static and shuffle modes allow the user to resize or maximize the selected window. Resizing can be accomplished by positioning a pointer over the lower right corner of the selected window and dragging the pointer until the desired window size is achieved. The upper left corner of the selected window does not move from its location in the cascade stack 18. The selected window returns to the same size as the other windows 14 upon its return to the cascade stack 18. A window 14 selected for a second time is displayed at the same window size that the window 14 had when displayed in the preferred display state immediately before its return to the stack 18 after the first selection.

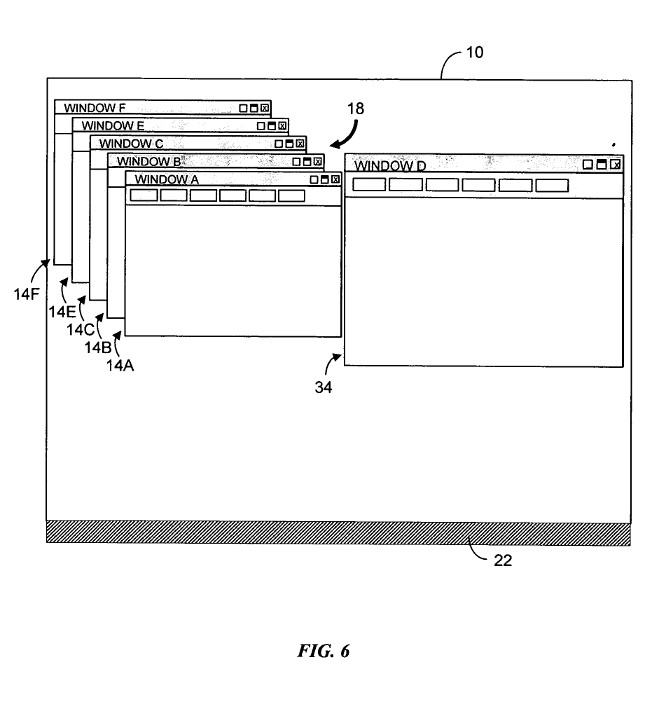

A window 14 can be permanently removed from the cascade stack 18 so that the window 14 no longer participates in cascade mode behavior. For example, one or more windows 14 (e.g., Notepad windows) can be removed from the cascade stack 18 and displayed in a new position in the display 10 beside the stack 18 as shown in FIG. 6. The user can move through the cascade stack 18 and copy and paste from the remaining windows 14 into the removed windows 34. A user can then return removed windows 34 to the cascade stack 18. Removal or return can be accomplished, for example, by depressing the shift key while the windows 14, 34 are dragged away from or onto the cascade stack 18.

Another feature of the method of the invention is the ability to quickly an easily display consecutive windows 14 in the stack 18 in the preferred display state regardless of which cascade mode is in use. A user can use the up and down arrow keys “↑” and “↓”, or any other pair of predetermined keys on a keyboard or other user input device, to “walk” forwards or backwards through the windows 14 in the stack 18. Referring to FIG. 3 as an example, depressing the “↑” key repeatedly will result in the sequential display of higher stack windows Window C 14C, Window B 14B and Window A 14A in the preferred display state. Continued use of the “↑” key results in windows 14 at the bottom of the stack 18 to be displayed sequentially. Conversely, depressing the “↓” key repeatedly will result in the sequential display of lower stack windows Window E 14E and Window F 14F in the preferred display state. Continued use of the “↓” key results in windows 14 at the top of the stack 18 to be displayed sequentially.

Still another feature allows the user to walk backwards and forwards in time through a history of window usage. For example, the user can use the right and left arrow keys “→” and “←”, or any other pair of predetermined keys, or key and mouse button pair, to display a prior history window or a subsequent history window from a selection history sequence.

While the invention has been shown and described with reference to specific preferred embodiments, it should be understood by those skilled in the art that various changes in form and detail may be made therein without departing from the spirit and scope of the invention as defined by the following claims. For example, although described as a method, the invention can be embodied as a computer readable medium (e.g., compact disk, DVD, flash memory, and the like) that is distributed in various commercial channels. Also, the computer readable instructions contained on the computer readable medium can be transferred across a network (e.g., Internet). Additionally, the invention can be embodied as a computer data signal embodied in a carrier wave.

What is claimed is:

1. A method of organizing a plurality of windows for display to a user, comprising:
displaying the windows in a cascade stack, each window having a first position in the cascade stack and an ordered position relative to the other windows;
selecting one of the windows to be an active window;
displaying the selected window in a preferred display state; and
displaying the selected window in the cascade stack in a second position.

2. The method of claim 1 wherein the first and second positions of the selected window in the cascade stack are the same position.

3. The method of claim 1 wherein the second position in the cascade stack is a top position.

4. The method of claim 3 further comprising displaying each window in the cascade stack based on the respective ordered position.

5. The method of claim 3 further comprising:
incrementing the ordered position of each window having an ordered position less than the ordered position of the selected window by one;
changing the ordered position of the selected window to one; and
displaying each window in the cascade stack based on the respective ordered position.

6. The method of claim 1 wherein the windows comprise a plurality of portlets provided by at least one web portal.

7. The method of claim 1 wherein the preferred display state comprises at least one of a maximized window, a user defined window size and a predetermined location in a display.

8. The method of claim 1 further comprising:
requesting a lower stack window; and
displaying in the preferred display state a window in the cascade stack having an ordered position that is one greater than the ordered position of the selected window.

9. The method of claim 1 further comprising:
requesting a higher stack window; and
displaying in the preferred display state a window in the cascade stack having an ordered position that is one less than the ordered position of the selected window.

10. The method of claim 1 further comprising:
requesting a display of a prior history window; and
displaying in the preferred display state a window that was previously displayed in the preferred display state immediately before the display of a window currently displayed in the preferred display state.

11. The method of claim 1 further comprising:
requesting a display of a subsequent history window; and
displaying in the preferred display state a window that was subsequently displayed in the preferred display state immediately after the display of a window currently displayed in the preferred display state.

12. A computer readable medium for organizing a plurality of windows for display to a user, the computer readable medium comprising instructions to cause a processor to:
display the windows in a cascade stack, each window having a first position in the cascade stack and an ordered position relative to the other windows;
enable the user to select one of the windows to be an active window;
display the selected window in a preferred display state; and
display the selected window in the cascade stack in a second position.

13. The computer readable medium of claim 12 wherein the first and second positions of the selected window in the cascade stack are the same position.

14. The computer readable medium of claim 12 wherein the second position in the cascade stack is a top position.

15. The computer readable medium of claim 14 further comprising instructions to cause the processor to:
increment the ordered position of each window having an ordered position less than the ordered position of the selected window by one;
change the ordered position of the selected window to one; and
display each window in the cascade stack based on the respective ordered position.

16. The computer readable medium of claim 12 further comprising instructions to cause the processor to:
enable the user to request a lower stack window; and
display in the preferred display state a window in the cascade stack having an ordered position that is one greater than the ordered position of the selected window.

17. The computer readable medium of claim 12 further comprising instructions to cause the processor to:
enable the user to request a higher stack window; and
display in the preferred display state a window in the cascade stack having an ordered position that is one less than the ordered position of the selected window.

18. The computer readable medium of claim 12 further comprising instructions to cause the processor to:
enable the user to request a display of a prior history window; and
display in the preferred display state a window that was previously displayed in the preferred display state immediately before the display of a window currently displayed in the preferred display state.

19. The computer readable medium of claim 12 further comprising instructions to cause the processor to:
enable the user to request a display of a subsequent history window; and
display in the preferred display state a window that was subsequently displayed in the preferred display state immediately after the display of a window currently displayed in the preferred display state.

20. A computer data signal embodied in a carrier wave for organizing a plurality of windows for display to a user, the computer data signal comprising:
program code for displaying the windows in a cascade stack, each window having a first position in the cascade stack and an ordered position relative to the other windows;
program code for selecting one of the windows to be an active window;
program code for displaying the selected window in a preferred display state; and
program code for displaying the selected window in the cascade stack in a second position.

21. The computer data signal of claim 20 wherein the first and second positions of the selected window in the cascade stack are the same position.

22. The computer data signal of claim 20 wherein the second position in the cascade stack is a top position.

23. The computer data signal of claim 22 further comprising:
program code for incrementing the ordered position of each window having an ordered position less than the ordered position of the selected window by one;
program code for changing the ordered position of the selected window to one; and
program code for displaying each window in the cascade stack based on the respective ordered position.

24. The computer data signal of claim 20 further comprising:
program code for enabling a user to request a lower stack window; and
program code for displaying in the preferred display state a window in the cascade stack having an ordered position that is one greater than the ordered position of the selected window.

25. The computer data signal of claim 20 further comprising:
program code for enabling a user to request a higher stack window; and
program code for displaying in the preferred display state a window in the cascade stack having an ordered position that is one less than the ordered position of the selected window.

26. The computer data signal of claim 20 further comprising:
program code for enabling a user to request a display of a prior history window; and
program code for displaying in the preferred display state a window that was previously displayed in the preferred display state immediately before the display of a window currently displayed in the preferred display state.

27. The computer data signal of claim 20 further comprising:
program code for enabling a user to request a display of a subsequent history window; and
program code for displaying in the preferred display state a window that was subsequently displayed in the preferred display state immediately after the display of a window currently displayed in the preferred display state.

28. An apparatus organizing a plurality of windows for display to a user, the apparatus comprising:
means for displaying the windows in a cascade stack, each window having a first position in the cascade stack and an ordered position relative to the other windows;
means for selecting one of the windows to be an active window;
means for displaying the selected window in a preferred display state; and
means for displaying the selected window in the cascade stack in a second position.

29. The apparatus of claim 28 further comprising:
means for requesting a lower stack window; and
means for displaying in the preferred display state a window in the cascade stack having an ordered position that is one greater than the ordered position of the selected window.

30. The apparatus of claim 28 further comprising:
means for requesting a higher stack window; and
means for displaying in the preferred display state a window in the cascade stack having an ordered position that is one less than the ordered position of the selected window.

31. The apparatus of claim 28 further comprising:
means for requesting a display of a prior history window; and
means for displaying in the preferred display state a window that was previously displayed in the preferred display state immediately before the display of a window currently displayed in the preferred display state.

32. The apparatus of claim 28 further comprising:
means for requesting a display of a subsequent history window; and
means for displaying in the preferred display state a window that was subsequently displayed in the preferred display state immediately after the display of a window currently displayed in the preferred display state.
